(19) United States
(12) Patent Application Publication
(10) Pub. No.: US 2024/0220200 A1
(43) Pub. Date: Jul. 4, 2024

(54) ARITHMETIC OPERATION PROCESSING DEVICE

(71) Applicant: OLYMPUS CORPORATION, Tokyo (JP)

(72) Inventor: Hideaki FURUKAWA, Akiruno-shi (JP)

(73) Assignee: OLYMPUS CORPORATION, Tokyo (JP)

(21) Appl. No.: 18/608,458

(22) Filed: Mar. 18, 2024

Related U.S. Application Data
(63) Continuation of application No. PCT/JP2021/042496, filed on Nov. 18, 2021.

(51) Int. Cl. G06F 7/02

(52) U.S. Cl. CPC G06F 7/023

(57) ABSTRACT

An arithmetic operation processing device configured to: store first data as a comparison target value, compare the comparison target value with a comparison value having data other than the first data, update the values based on the comparison, sequentially acquire the comparison values and acquire the comparison target values of the comparison update parts, read data that initially becomes the K comparison target values, transmit the K comparison target values to the K comparison update parts of the data comparing part, when all the comparison target values are read from the data storage buffer, read all data other than the data that becomes the comparison target values from the data storage buffer, and in a case in which comparison of a second time or a subsequent time is performed, reflect update details until comparison of the previous time in the data and output resultant data to the comparison update part.

### CROSS-REFERENCE TO RELATED APPLICATIONS

The present application is a continuation application based on PCT Patent Application No. PCT/JP2021/042496, filed on Nov. 18, 2021, the entire content of which is hereby incorporated by reference.

### BACKGROUND

### Field of the Invention

The present invention relates to an arithmetic operation processing device.

### Description of Related Art

Conventionally, there are arithmetic operation processing devices executing arithmetic operations using a neural network in which a plurality of processing layers are hierarchically connected. Particularly, in an arithmetic operation processing device performing image recognition, deep learning using a convolutional neural network (hereinafter referred to as a CNN) is broadly performed.

FIG. 1 is a diagram illustrating an example of a process of image recognition through deep learning using a CNN. In image recognition through deep learning using a CNN, by sequentially performing processes in a plurality of processing layers of the CNN for input image data (pixel data), final arithmetic operation result data in which target objects included in the image are recognized can be acquired.

The processing layers of a CNN can be largely classified into a convolution layer that performs a convolution process including a convolution operation process, a nonlinear process, a reduction process (pooling process), and the like and a full connect layer (fully-coupled layer) that performs a full connect process in which all the input data (pixel data) is multiplied by filter coefficients, and results thereof are accumulatively added. Here, there is also a neural network in which no full connect layer is present.

Image recognition through deep learning using a CNN is performed as follows. First, for image data, a combination of a convolution operation process in which a certain area is extracted and is multiplied by a plurality of filters of which filter coefficients are different from each other to generate a feature map (FM) and a reduction process (a pooling process) of reducing a partial area of the feature map is set as one process layer, and this is performed several times (a plurality of process layers). Such processes are processes of the convolution layer.

In a convolution process, first, one pixel and pixels in the vicinity thereof are extracted from image data, and filter processes of which filter coefficients are different from each other are performed for the pixels (a convolution operation process). By accumulatively adding all of these, data corresponding to one pixel is generated. For the generated data, a nonlinear conversion and a reduction process (a pooling process) are performed, and the processes described above are performed for all the pixels of the image data, whereby an output feature map (oFM) corresponding to one face is generated. By repeating this several times, oFMs corresponding to a plurality of faces are generated. In an actual circuit, everything described above is pipeline processed.

By further performing a filter process of which a filter coefficient is different using the generated output feature map (oFM) as an input feature map (iFM) of the next convolution process, the convolution process is repeated. In this way, the convolution process is performed a plurality of number of times, and an output feature map (oFM) is acquired.

FIG. 2 is an image diagram for acquiring an output feature map (oFM) from an input feature map (iFM) by performing a convolution process. In the convolution process, different filter coefficients are applied to all the input iFM data (filter processes), all the results thereof are accumulatively added, and processes such as a non-linear conversion, pooling (a reduction process), and the like are performed, whereby oFM data is acquired. As information that is necessary for calculating one pixel of the oFM data, information of all the pixels present in the vicinity of coordinates of iFM data corresponding to an output (one pixel of the oFM) (iFM data and filter coefficients) is necessary.

Convolution processes such as a filter process, accumulative adding, nonlinear conversion, pooling, and the like are performed for an input feature map (iFM) of N faces, and output feature maps (oFM) of M faces are output. Input feature maps (iFM) of N faces (N dimensions) are processed in parallel, and output feature maps (oFM) of M faces (M dimensions) are output in parallel. Here, N and M are integers equal to or greater than 1. This process can be realized using a circuit configuration of input N parallel×output M parallel.

When the convolution process advances, and the feature map (FM) is decreased to a certain degree, image data is read and changed into a data column of one dimension. A full connect process of multiplying each piece of data of this data column of one dimension by different coefficients and accumulatively adding results thereof is performed a plurality of times (in a plurality of processing layers). Such processes form a process of a fully-coupled layer (a full connect layer).

After the full connect process, a process of detecting and estimating a subject from an acquired feature quantity (a subject estimating process) is performed. As a result of the subject estimating process, a probability of a target object included in an image (a subject detection probability) being detected is output. In the example illustrated in FIG. 1, as final arithmetic operation result data, a probability of a dog being detected is 0.01 (1%), a probability of a cat being detected is 0.04 (4%), a probability of a boat being detected is 0.94 (94%), and a probability of a bird being detected is 0.02 (2%).

By only displaying objects shown in an original image with probabilities, the CNN illustrated in FIG. 1 completes the process. In other words, information of a place at which a subject is shown with a certain size cannot be acquired. However, in a digital camera and the like, a place at which a subject is shown with a certain size needs to be acquired. In that case, information acquired by the CNN illustrated in FIG. 1 is insufficient, and position information, size information, and the like need to be acquired.

Generally, in an image captured by a photographer, various subjects are shown. For this reason, a plurality of (in description presented below, M types of) various subjects need to be detected from an image. Although a CNN outputting such information can be generated, there are various problems to be described below, and therefore in the present invention, a process of extracting only information desired to be acquired for an output result of the CNN(=a subject estimating process) is performed.

One example of the subject estimating process will be described. A feature quantity of a subject that is an output result of a CNN that is a target in the present invention is a plurality of (N) information sets having the following information as one part.
position information of subject
magnitude (size) information of subject
reliability information of subject
class reliability information (M dimensions)

FIG. 3 is a diagram illustrating an example of details of an information set. A CNN that is a target in the present invention outputs N high dimensional data (positions, sizes, subject reliability, and class reliability) illustrated in FIG. 3. In addition, details of the information set differ in accordance with a network. The position information of a subject is a position (X, Y) of the subject inside an image. The magnitude (size) information of a subject is a size (W, H) of the subject inside an image. The reliability information of a subject is an index that represents a likelihood of being a subject.

The class reliability information represents class reliability (a degree of reliability) and, for example, is “dog” 70%, “cat” 10%, and the like. As the class reliability information of the M dimensions, M types of subjects desired to be divided into classes can be prepared. For example, in the class reliability information, a likelihood 70% of a subject being a “dog” is written into a first dimension, a likelihood 10% of a subject being a “cat” is written into a second dimension, and this is continued up to an M-th dimension.

In addition, since there is high noise in accordance with this result alone, for an output information set, only information of which noise is desired to be reduced in the subject estimating process is picked up. FIG. 4 is image data for which image recognition is performed, and a dog, a bicycle, and a truck are included as subjects. In the subject estimating process, an information set is acquired. In FIG. 5, results after the end of the subject estimating process that are images at the time of displaying all position information and size information of subjects extracted from the acquired information set as frames on an image are caused to overlap each other on the image by firmware (or a GPU circuit) as frames.

In the subject estimating process, as illustrated in FIG. 5, the same subject is frequently detected in a plurality of information sets. For example, in FIG. 5, three boundary boxes representing information sets of a dog, three boundary boxes representing information sets of a bicycle, and two boundary boxes representing information sets of a truck are drawn, and in this way, information sets of the same subject come out in large quantities. In order to prevent this, it is necessary to exclude duplicate information sets by causing only an information set having the highest class reliability to remain.

Thus, an IOU acquired by calculating a degree of overlapping of frames as a numerical value is calculated. When information sets for which an IOU is large are present, only an information set having high class reliability is caused to remain, and the value of an information set having low class reliability is set to zero.

FIG. 6 is a diagram representing a degree of overlapping of frames (IOU) at the time of displaying position information and size information of a subject extracted from information sets on an image as frames. The IOU is a ratio of an overlapping part c between an information set P and an information set Q with respect to the entirety. When an area of the information set P acquired by excluding the overlapping part is denoted by p, an area of the information set Q acquired by excluding the overlapping part is denoted by q, and an area of the overlapping part is denoted by c, IOU=c/p+q+c. This is one example, and, for example, it may be configured such that IOU=c/p+q.

In an arithmetic operation for acquiring an IOU, in order from the beginning of N information sets, in a round robin, comparison of magnitudes of two pieces of class reliability information is performed, and only an information set having higher class reliability is caused to remain (a value of an information set having lower class reliability is changed). Although it depends on a model that is employed, N may be several thousands, and M may be several tens, and in that case, the number of comparisons becomes several tens of millions. Round robin processes of the comparison arithmetic operations are performed in parallel. Since processes of that quantity are necessary for one frame, in a case in which a moving image frame rate is 60 fps, the number of comparisons is over one hundred million, and even when pipeline processing is performed, there is a problem in that the processing time becomes too long.

### SUMMARY

As described above, in an arithmetic operation for acquiring an IOU, all the information sets are compared and updated in order from the beginning in a round robin, and thus there is a problem in that a processing time of an arithmetic operation of performing comparison of magnitudes of class reliability information of information sets formed from feature quantities of subjects needs to be shortened in a subject estimating process.

Japanese Unexamined Patent Application, First Publication No. 2017-4480 (Patent Document 1) proposes a method of improving reliability of “remarkability” calculated from feature quantities acquired using a deep neural network (DNN). The remarkability that is initially acquired in the process of calculating remarkability is processed to be corrected. However, there is no mention about speeding up the process in Patent Document 1. This is considered to be because the number of feature quantities is small or the system is not a system handling a moving image.

On the basis of the situations described above, an object of the present invention is to shorten a processing time of an arithmetic operation performing comparison of magnitudes of information sets in an arithmetic operation processing device.

One aspect of the present invention is an arithmetic operation processing device including: a comparison update part configured to store first data of a data stream of an input information set as a comparison target value, compare the comparison target value with a comparison value by using data other than the first data as the comparison value, update both of the values on the basis of a comparison result, and output the updated comparison value to a later stage; a data comparing part in which K comparison update parts are connected in multiple stages; a data storage buffer, in which N information sets that are data columns are stored, formed from a memory; a data acquiring part configured to sequentially acquire the comparison values that are output data of the comparison update parts connected in the multiple stages and thereafter acquire the comparison target values of the comparison update parts; and a memory control part, in which the memory control part consecutively reads the information sets from a data stream stored in the data storage buffer, reads data that initially becomes the K comparison target values, and transmits the K comparison target values to the K comparison update parts of the data comparing part when all the comparison target values are read from the data storage buffer, next, reads all data other than the data that becomes the comparison target values from the data storage buffer; and in a case in which comparison of a second time or a subsequent time is performed, reflects update details until comparison of the previous time in the data acquired from the data storage buffer and outputs resultant data to the comparison update part.

A zero information buffer formed from a memory in which zero information that can be used for identifying whether or not an updated data element is zero is stored may be further included, and the data acquiring part may write zero information that can be used for identifying a data element of which a value has been updated into the zero information buffer when the comparison values present in output data of the comparison update parts connected in the multiple stages are sequentially acquired and write zero information in the zero information buffer also for the comparison target value when the comparison target value is acquired from the comparison update part after acquisition of all the comparison values from the comparison update parts ends; and in a case in which comparison of a second time or a subsequent time is performed, the memory control part may simultaneously read zero information forming a pair with a data element to be compared from the zero information buffer, reflect update details until comparison of the previous time in data acquired from the data storage buffer, and output resultant data to the comparison update part.

In a case in which, as a result of reflection of change details in data, the value becomes a value that does not need to be compared with the other data anymore, the memory control part may exclude the data as invalid data from the data stream.

In a case in which the stored comparison target value becomes a value that does not need to be compared with other data anymore, the comparison update part may perform through output of the data without performing comparison/update.

The comparison update part may receive a comparison/update execution/non-execution determination signal in synchronization with stream data as its input and perform comparison/update of the data only when the comparison/update execution/non-execution determination signal indicates execution.

The information set may be an information set formed from a feature quantity of a subject in a subject estimating process of a later stage of a CNN using deep learning, each information set may include class reliability information having independent elements of M dimensions, the arithmetic operation processing device may further include a position/size information storage buffer in which a position and a size of a detected subject are stored having 1:1 correspondence with the class reliability information, in which the comparison/update performed by the comparison update part may be an operation of comparing values of the class reliability information for each dimension and substituting a smaller value with zero, zero information stored in the zero information buffer may be information that can be used for determining whether or not a value of the class reliability information for each dimension is zero, and the comparison update part may calculate an IOU that is a numerical value representing an overlapping degree of frames from the position/size information corresponding to the class reliability information to be compared and perform comparison/update only when the IOU is equal to or greater than a predetermined threshold.

The zero information stored in the zero information buffer may be a flag in which a part in which the value of the class reliability information for each dimension is zero is set as 1, and the other parts are set as 0, and when all the zero information of the zero information buffer is 1, the memory control part may determine that comparison with other data is not necessary.

According to each aspect of the present invention, a processing time of an arithmetic operation performing comparison of magnitudes of information sets can be shortened in an arithmetic operation processing device.

### BRIEF DESCRIPTION OF THE DRAWINGS

FIG. 1 is a diagram illustrating an example of a process of image recognition through deep learning using a CNN.

FIG. 2 is an image diagram acquiring an output feature map (oFM) from an input feature map (iFM) through a convolution process.

FIG. 3 is a diagram illustrating an example of details of an information set.

FIG. 4 is image data for which image recognition is performed.

FIG. 5 is an image acquired when all position information and size information of subjects extracted from an acquired information set are displayed on an image as frames.

FIG. 6 is a diagram illustrating an overlapping degree (IOU) of frames at the time of displaying position information and size information of subjects extracted from information sets on an image as frames.

FIG. 7 is a diagram illustrating an example in which three subjects A, B, and C are present in close formation in image data.

FIG. 8 is a diagram illustrating a result of a comparison update process of a case in which orders of the comparison/update are different.

FIG. 9 is a diagram illustrating a configuration of an information set.

FIG. 10 is a diagram illustrating a comparison update process of a first time according to a first embodiment of the present invention.

FIG. 11 is a diagram illustrating a comparison update process of a second time or a subsequent time according to the first embodiment of the present invention.

FIG. 12 is a diagram illustrating an example of a circuit (an arithmetic operation processing device) performing a parallel process according to the first embodiment of the present invention.

FIG. 13 is a timing diagram illustrating a data process in each comparison update part.

FIG. 14 is a diagram illustrating a comparison update process of a case in which all the elements of an information set are zero at the time of acquisition of data.

FIG. 15 is a diagram illustrating a comparison update process of a case in which all the elements of a target comparison value side become zero in the middle of the process.

FIG. 16 is a timing diagram illustrating a data process according to a second embodiment of the present invention.

FIG. 17 is a timing diagram illustrating a cycle of a data process.

FIG. 18 is a block diagram illustrating a class reliability determining part according to a third embodiment of the present invention.

FIG. 19 is a diagram illustrating an example of a reliability determination result acquired by a determination part.

FIG. 20 is a diagram illustrating an example of a timing diagram according to the third embodiment of the present invention.

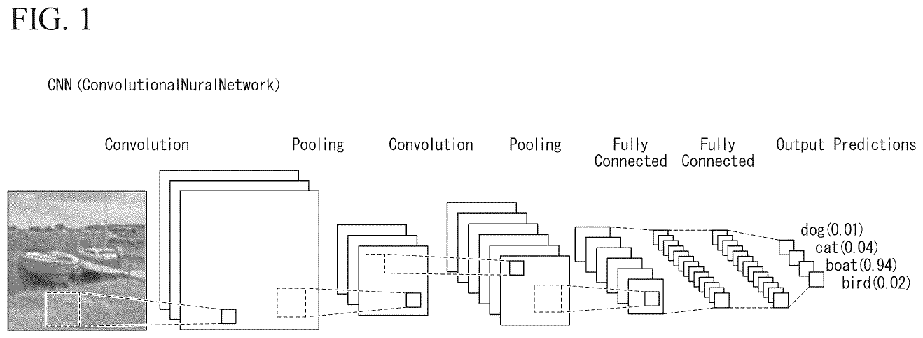

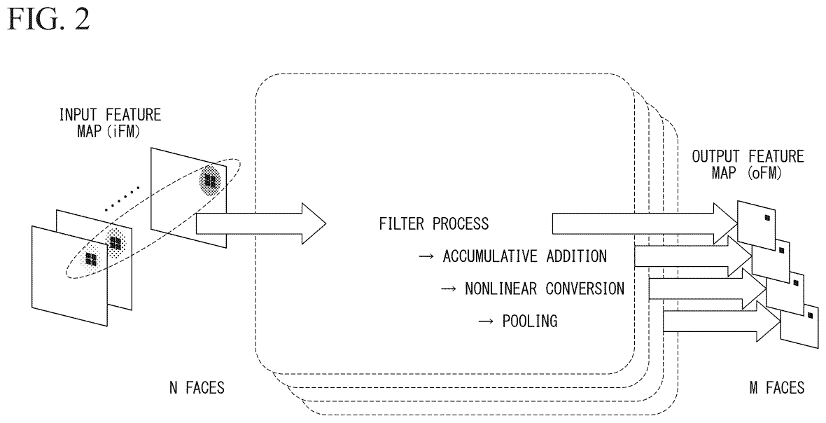

### DETAILED DESCRIPTION

In an information set, a class reliability part is extracted and is set as an array D[n]. Each D[n] has information of M dimensions (here, M is an integer equal to or greater than 0). When a process of comparing and updating a p-th element and a q-th element of D[n] is denoted by a function f(D[p], D[q]), the comparison update process becomes D[·] that is acquired after executing the following Equation (1). Every time the comparison update process is performed once, the elements of D[n] are updated.

$${\sum }_{n = 1}^{N} {\sum }_{m = n + 1}^{N} f ( D [ n ] , D [ m ] ) \qquad ( 1 )$$

Although this process is desired to be performed at a higher speed through parallel processing, the order of comparison and update needs to be kept. In cases in which subjects of the same class are present in close formation, a case in which the orders of comparison/update are different from each other will be considered. FIG. 7 illustrates an example in which three subjects A, B, C are present in close formation in image data. Between A and B, the IOU is small, and thus the subjects are considered to be different subjects, and a comparison update process between A and B is not performed. Between A and C, the IOU is large, and thus the class reliabilities are compared and updated. Similarly, between B and C, the IOU is large, and thus class reliabilities are compared and updated.

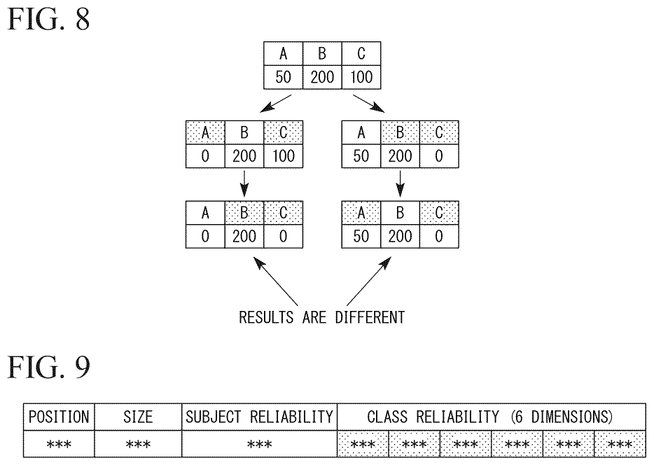

In such a case, when the order of comparison/update are different, the results are different. FIG. 8 is a diagram illustrating results of the comparison update processes of a case in which the orders of comparison/update are different. The class reliability of the subject A is 50, the class reliability of the subject B is 200, and the class reliability of the subject C is 100.

On a left side of FIG. 8, first, between A and C, a comparison update process is performed, the class reliability of C is large, and thus the class reliability of A is updated with 0. Next, a comparison update process is performed between B and C, the class reliability of B is large, and thus the class reliability of C is updated with 0. As results of the comparison update processes, the class reliability of the subject A becomes 0, the class reliability of the subject B becomes 200, and the class reliability of the subject C becomes 0.

On a right side of FIG. 8, first, between B and C, a comparison update process is performed, the class reliability of B is large, and thus the class reliability of C is updated with 0. Next, a comparison update process is performed between A and C, the class reliability of A is large, and thus the class reliability of C is maintained to be 0. As results of the comparison update processes, the class reliability of the subject A becomes 50, the class reliability of the subject B becomes 200, and the class reliability of the subject C becomes 0. For this reason, on the left side and the right side of FIG. 8, the results of the comparison update processes are different from each other.

In this way, when the order of the comparison update process is changed, there is a possibility of the result being changed, and thus the order of the comparison update process needs to be not changed. Thus, the point of the present invention is to perform parallel processing of this such that the order of the comparison update process is not changed. In other words, a circuit that is capable of parallel processing without changing the order of Equation (1) is realized.

### First Embodiment

A first embodiment of the present invention will be described with reference to the drawings. First, a method of comparing information sets will be described. FIG. 9 is a diagram illustrating a configuration of an information set. Hereinafter, a class reliability part of the information set will be focused in description. The class reliability will be assumed to be in 6 dimensions.

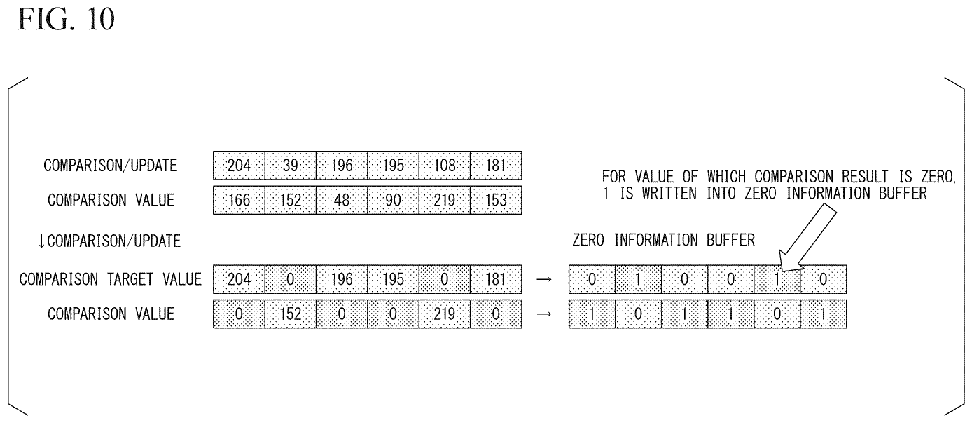

FIG. 10 is a diagram illustrating a comparison update process of a first time according to this embodiment. Class reliabilities of two information sets stored in an information set storage buffer are compared with each other. The class reliability of one information set will be referred to as a “comparison target value”, and the class reliability of the other information set will be referred to as a “comparison value”. A comparison target value and a comparison value are compared with each other for each dimension, and the smaller value is substituted with zero. Then, a flag 1 is written into a zero information buffer corresponding to a part for which a comparison result is zero. As a result, a zero information buffer corresponding to a larger value of the class reliability is maintained to have a flag 0. In this way, an updated value is not written back into the information set storage buffer, and information relating to a rewritten part (zero information) is stored in another buffer (the zero information buffer).

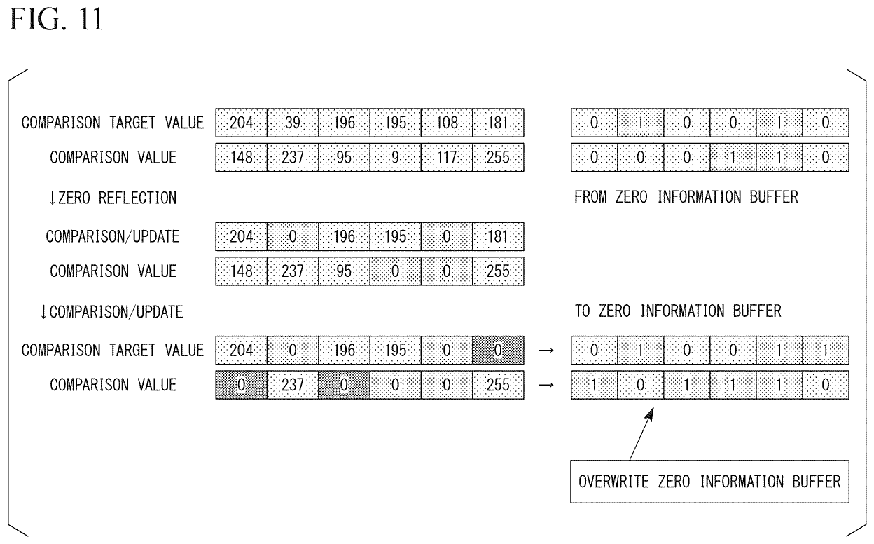

FIG. 11 is a diagram illustrating a comparison update process of a second time or a subsequent time according to this embodiment. First, in class reliabilities of two information sets stored in the information set storage buffer, change information acquired from the zero information buffer is reflected. In other words, a value of the class reliability corresponding to a part in which the flag 1 is written in the zero information buffer is substituted with zero (zero reflection). Then, elements of the class reliabilities of two information sets in which zero is reflected are compared with each other, and a value of a smaller element is substituted with zero (comparison/update). In this way, in the comparison update process of the second time or a subsequent time, after change information acquired from the zero information buffer is reflected, comparison is performed. Then, the flag 1 is overwritten into the zero information buffer corresponding to the value of which the comparison result was zero.

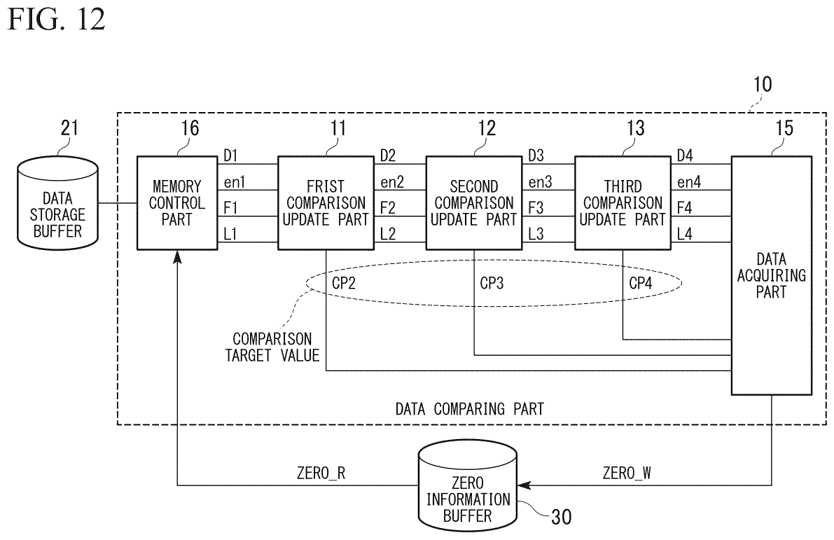

FIG. 12 is a diagram illustrating an example of a circuit (an arithmetic operation processing device) performing a parallel process according to this embodiment. The arithmetic operation processing device 1 includes a data comparing part 10, a data storage buffer 20, and a zero information buffer 30. The data storage buffer 20 is formed from a memory in which N data columns (information sets) are stored. The zero information buffer 30 is formed from a memory in which details that can be used for identifying whether an updated data element is zero are stored.

The data comparing part 10 includes comparison update parts 11, 12, and 13 connected in multiple stages, a data acquiring part 15, and a memory control part 16. Although the number of stages (corresponding to a parallel degree) of the comparison update parts can be arbitrarily set, in this example, the parallel degree K=3, that is, three-parallel. Each comparison update part stores the beginning of a data stream (D*) that is initially input as a comparison target value (CP*). Then, each comparison update part sets another data (data input at the second time or a subsequent time) as a comparison value and sequentially compares a comparison target value with the comparison value, updates both the values in accordance with a result thereof, and outputs the comparison value to a later stage.

More specifically, a first comparison update part 11 continues to store first data (D1) as a comparison target value and performs comparison and update using data of the second time or a subsequent time (D2, D3, . . . , DN) as a comparison value. A second comparison update part 12 continues to store second data (D2) as a comparison target value and performs comparison and update using data of the third time or a subsequent time (D3, D4, . . . , DN) as a comparison value. A third comparison update part 13 continues to store third data (D3) as a comparison target value and performs comparison and update using data of the fourth time or a subsequent time (D4, D5, . . . , DN) as a comparison value. In accordance with such a configuration, the comparison and update of the first data, the comparison and update of the second data, and the comparison and update of the third data can be performed at the same time.

The data acquiring part 15 sequentially acquires output data of the comparison update parts connected in multiple stages and writes out details (zero information) that can be used for identifying elements of which values have been updated into the zero information buffer 30. Then, when acquisition of all the data ends, the data acquiring part 15 writes out similar information (zero information) also for a comparison target value of the comparison update part.

The memory control part 16 controls the data storage buffer 20 and the zero information buffer 30. The memory control part 16 reads all the data starting from data that is a comparison target value and repeats this. The memory control part 16 does not perform an access to data for which comparison/update with all the data have ended.

More specifically, the memory control part 16 consecutively reads N pieces of data from a data stream stored in the data storage buffer 20 and reads data that becomes initially K comparison target values. The K comparison target values are respectively transmitted to K (three in the example illustrated in the drawing) comparison update parts of the data comparing part 10. When all the comparison target values are read from the data storage buffer 20, next, the memory control part 16 reads the other data (all data other than the data that has become comparison target values) from the data storage buffer 20. Also at this time, the K pieces of data from the start are set as comparison target values.

In a case in which comparison of the second time or a subsequent time is performed, the memory control part 16 simultaneously reads data from the zero information buffer that forms a pair with the data element, reflects change details up to the previous time in the data acquired from the data storage buffer, and outputs resultant data.

In this way, by consecutively inputting N information sets from a memory to a circuit in a processing order and repeating this several times, the process of comparison/update in a round robin can be performed in parallel without changing the processing order. In accordance with this, the process can be performed at a higher speed.

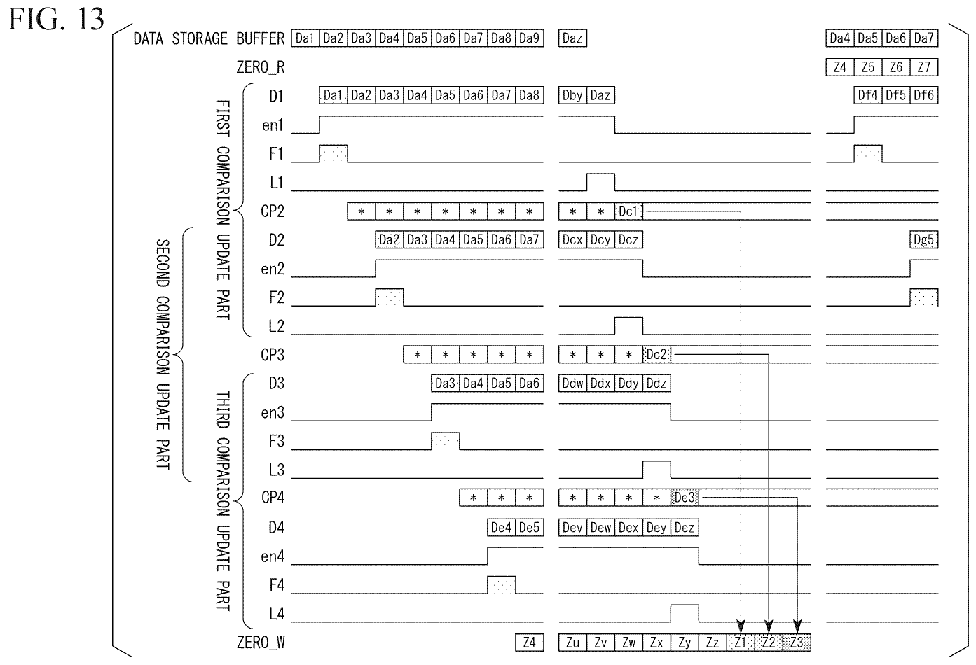

FIG. 13 is a timing diagram illustrating a data process in each comparison update part. In addition, in details of the comparison and update process, an actual method for parallelization of processes is arbitrary. However, in order to secure consistency in the following description, the process will be described as a process of comparing class reliability information (reliability) of information sets for each dimension and setting a smaller value to zero.

In the drawing, one box D** represents one information set, and a numerical value disposed at the end thereof is an ID of the information set and corresponds to n of an array D[n] of the information set. In addition, z is the number N of information sets. A center subscript (a, b, c, . . . ) of D** represents a procedure in which a value that has been compared and updated changes. In addition, a signal L* is a signal used for identifying a last information set.

At a first time, no data is present in the zero information buffer (ZERO_R). First, the memory control part reads all data from the data storage buffer starting from a data column (=an information set) D**. The memory control part outputs the data column D** together with an effectiveness signal en* indicating effectiveness. When data is output, the data is output to a later stage with a signal F* used for identifying the start being attached to a first information set and a signal L* used for identifying the last being attached to a last information set.

In the first comparison update part, a data column (Da1, . . . , Daz) is input from the data storage buffer, and D1(Db1, . . . , Dbz) is formed. At the same time, an effectiveness signal en1, a signal F1 used for identifying the start, and a signal L1 used for identifying the last are input. The first comparison update part stores the first information set (Db1) input together with F1 as a comparison target value CP2, sequentially compares/updates data (Db2, . . . , Dbz) input next as a comparison value with CP2 (=Db1), and then outputs the comparison value side to a later stage. In the drawing, CP2 represents a register, and the value changes in accordance with comparison/update. D2 (Dc2, . . . , Dcz) is a data column output from the first comparison update part to a later stage (the second comparison update part).

In the second comparison update part, a data column D2(Dc2, . . . , Dcz) is input from the first comparison update part. At the same time, an effectiveness signal en2, a signal F2 used for identifying the start, and a signal L2 used for identifying the last are input. The second comparison update part stores the first information set (Dc2) input together with F2 as a comparison target value CP3, sequentially compares/updates data (Dc3, . . . , Dcz) input next as a comparison value with CP3 (=Dc2), and then outputs the comparison value side to a later stage. In the drawing, CP3 represents a register, and the value changes in accordance with comparison/update. D3 (Dd3, . . . , Ddz) is a data column output from the second comparison update part to a later stage (the third comparison update part).

In the third comparison update part, a data column D3 (Dd3, . . . , Ddz) is input from the second comparison update part. At the same time, an effectiveness signal en3, a signal F3 used for identifying the start, and a signal L3 used for identifying the last are input. The third comparison update part stores the first information set (Dd3) input together with F3 as a comparison target value CP4, sequentially compares/updates data (Dd4, . . . , Ddz) input next as a comparison value with CP4 (=Dd3), and then outputs the comparison value side to a later stage. In the drawing, CP4 represents a register, and the value changes in accordance with comparison/update. D4 (De4, . . . , Dez) is a data column output from the third comparison update part to a later stage.

In the zero information buffer, a flag 1 is written when the value of a corresponding element is zero, and a flag 0 is written otherwise. The data acquiring part substitutes elements of an information set that are parts having these values to be 1 with zero and outputs the information set to a later stage. For the convenience of description, although zero information is drawn as an image having a 1:1 correspondence with data, zero information may be one bit for one element, and thus zero information of one information set is read at once and is stored in an internal register.

An output of a final stage of the comparison update part is acquired by the data acquiring part, and the flag 1 is written into the zero information buffer when the data element is zero, or the flag 0 is written therein otherwise. In addition, when a signal L4 is received, the data acquiring part regards that the information set is the last information set in accordance with the signal, sequentially acquires comparison target values (CP2=Dc1, CP3=Dd2, CP4=De3) kept in each comparison update part after the end of the output to the zero information buffer, and writes zero information (ZERO_W) into the zero information buffer (Z1, Z2, and Z3).

As above, the comparison update parts of three stages have mutually-different comparison target values and perform comparison/update with all the data in parallel with the order kept, and update results are stored in the zero information buffer. Thereafter, similarly, while the start address is increased by K each time, the process is repeated until the start address equals to N or exceeds N, whereby Equation (1) described above can be executed. In a case in which information sets are not divisible by a parallel degree K, data of all zeros having no influence on the comparison update process may be added and input.

When an information set is compared and updated once or more, there is a possibility of the values being changed. In this embodiment, without updating the data storage buffer, corresponding data is read from the zero information buffer storing changes of data, and update results of the information set are reflected.

In accordance with such a configuration, in this embodiment, by consecutively inputting N information sets from a memory to a circuit in the processing order and repeating the process several times, the process of comparison/update in a round robin can be performed in parallel without changing the processing order. In other words, the process can be performed without changing the order of comparison even in parallel processing, results having high accuracy can be acquired, and there is an effect on the improvement of the processing speed of subject recognition.

### Second Embodiment

Next, a second embodiment of the present invention will be described. In the first embodiment, although the update process is “setting a smaller value to zero”, in a case in which all the elements of a certain information set are zero, the result is the same when comparison/update are performed. Thus, in a first example of this embodiment, first, data of a zero information buffer is read, and, in a case in which it is determined that there is no change in a comparison/update result, in other words, all the element values of an information set are zero, the data is invalided.

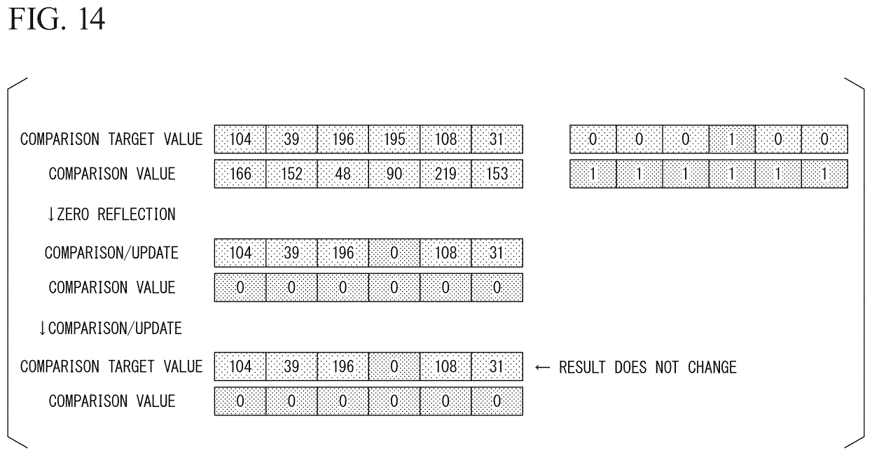

FIG. 14 is a diagram illustrating a comparison update process of a case in which all the elements of an information set are zero at the time of acquisition of data. Similar to the comparison/update process of the second time or a subsequent time according to the first embodiment, in class reliabilities of two information sets stored in an information set storage buffer, change information acquired from a zero information buffer is reflected. In other words, a value of the class reliability corresponding to a part in which a flag 1 is written in the zero information buffer is set to zero (zero reflection).

At this time, it is assumed that all the elements of the zero information buffer of a comparison value are the flag 1. When zero reflection is performed, all the elements of the information set of the comparison value become zero. Then, elements of the class reliabilities of two information sets in which zero is reflected are compared with each other, and a value of each smaller side is substituted with zero (comparison/update). However, since all the elements of the information set of the comparison value are zero, there is no change in the result of the comparison/update.

Thus, in this example, when data of the zero information buffer is read, and it is determined that all the element values of the information set are zero, the data is invalidated. In other words, data of the zero information buffer is read, and in a case in which all the elements of the zero information buffer are the flag 1, the data is invalided. The data may be excluded from a data stream as invalid data.

In this way, in this example, an information set having no influence on a comparison result is excluded, and data is through output without performing comparison/update, whereby the process can be performed at a higher speed, and the power consumption can be reduced.

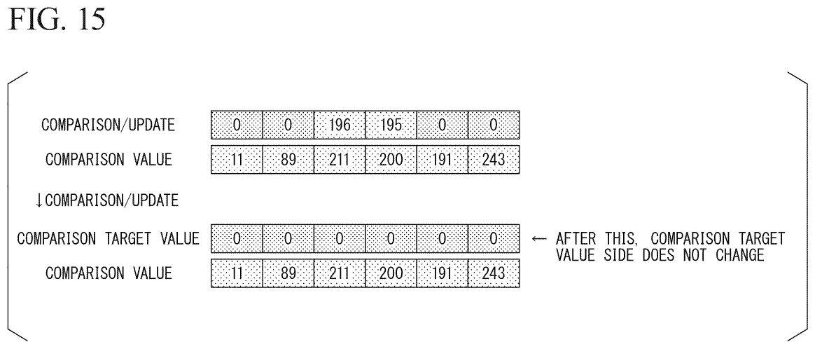

Next, a second example of this embodiment will be described. FIG. 15 is a diagram illustrating a comparison update process of a case in which all the elements of a target comparison value side become zero in the middle of the process. In the case illustrated in FIG. 15, after the comparison update process, all the elements of the comparison target value are set to zero in the middle of the process. After such a state is formed, there is no change in the comparison value side also after the comparison/update process is performed. In other words, after such a state is formed, comparison with a comparison value does not need to be performed.

Thus, in this example, in a case in which a comparison target value that is stored becomes a value that does not need to be compared with other data anymore, data is through output without performing comparison/update. In the example illustrated in the drawing, in a case in which all the elements of a comparison target value become zero in the middle of the process, thereafter, comparison with a comparison value is not performed.

In this way, in this example, when the comparison target value comes to have no influence on the comparison update process, comparison/update is not performed. In other words, an information set that has come to have no influence on a comparison result is excluded, and data is through output without performing comparison/update, whereby the process can be performed at a higher speed, and power consumption can be reduced.

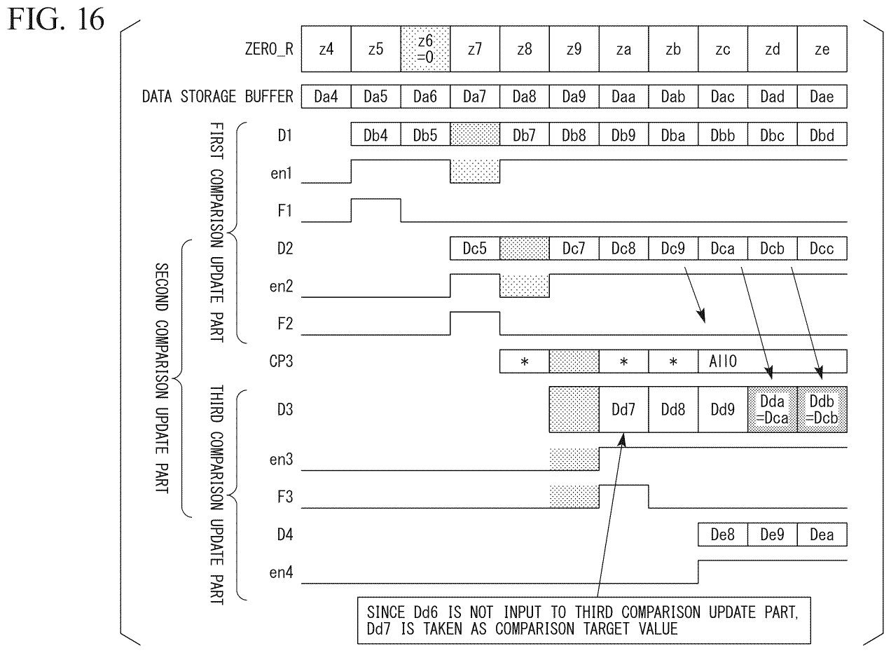

FIG. 16 is a timing diagram illustrating a data process according to this embodiment. In this case, in a value (ZERO_R) extracted from the zero information buffer, all the elements of z6 are zero. Thus, unnecessary data Da6 from the data storage buffer is prevented from being transmitted to the first comparison update part at the entrance. In addition, although CP3 is a comparison target value of which an initial value is Dc5, as a result of comparison/update with Dc9, all the elements become zero from a certain time point, and for an input thereafter (after Dca), a comparison/update function stops, and the input is through output as it is. Furthermore, since a signal corresponding to Dc6 is not input to the third comparison update part, Dc7 is taken as a comparison target value.

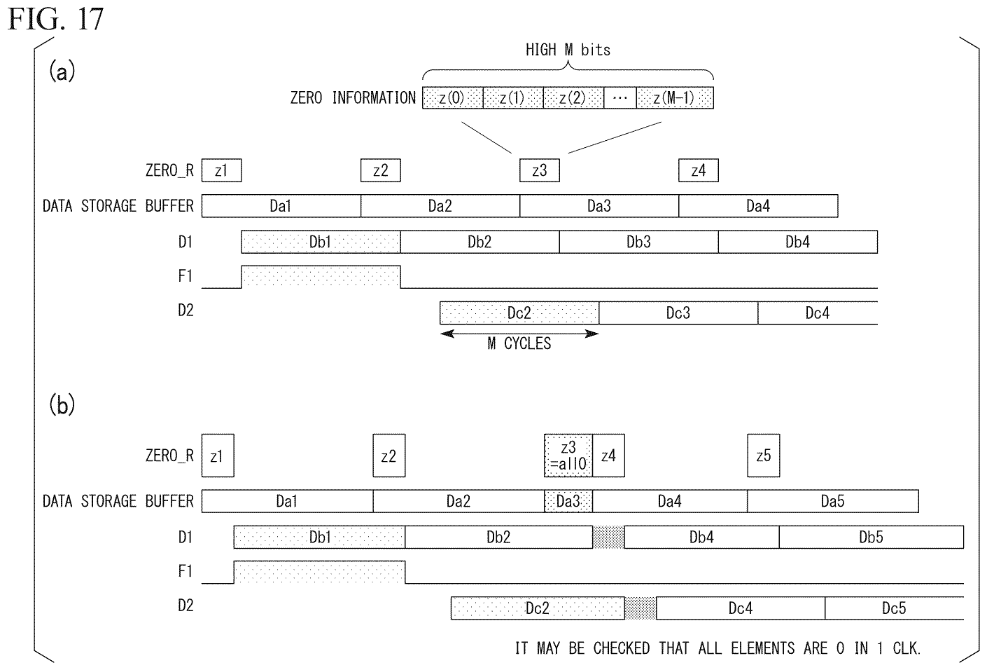

FIG. 17 (a) and (b) are timing diagrams illustrating a cycle of a data process. In FIG. 17 (a), in a circuit processing one piece of data in each cycle, M-bits data is processed in M cycles. In a case in which all the elements are zero, a part of z6 in which all the elements are zero is seen such that an empty cycle of the process is generated. In other words, in FIG. 16, in a case in which all the elements of an information set become zero by reflecting information of the zero information buffer, en becomes zero, and it appears that invalid data flows.

Actually, since one box is a data set, in the case of all zeros, the process can be skipped with one cycle without covering an M-cycle process. In other words, as illustrated in FIG. 17 (b), in a case in which it is known that all the elements of z3 are zero, the process can be performed by reducing M cycles to one cycle, and the process can be performed at a higher speed.

As described above, since acquisition of data of M dimensions corresponding to an information set can be extracted from the zero information buffer in a short cycle (for example, one cycle), it can be immediately determined that comparison/update is not performed. In other words, it can be recognized whether all the elements are zero in one clock.

In addition, in a case in which data of which all the elements are zero described above is generated in first K (=parallel degree number) information sets, the loop may be increased until the K information sets are acquired by skipping the information set.

### Third Embodiment

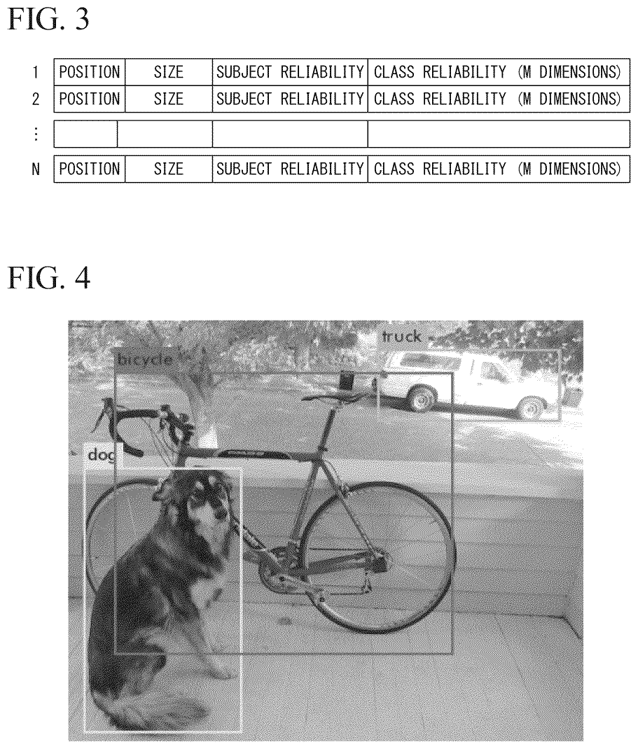

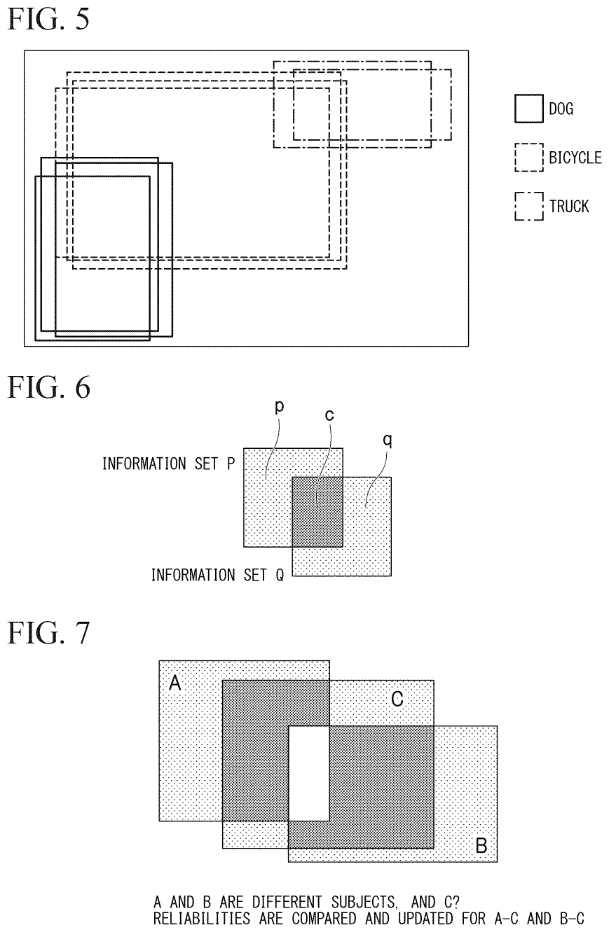

Next, a third embodiment of the present invention will be described. In this example, an application to a subject estimating process in deep learning will be described as an example. As in FIG. 3, a final output of a CNN is N information sets of M dimensions. From these information sets, subject reliability is calculated. At that time, as illustrated in FIG. 6, an IOU is calculated from position/size information by focusing on P-th and Q-th information sets.

In a case in which the IOU is larger than a predetermined threshold, the overlapping degree of subjects is large, and there is a high possibility of being the same subject. Thus, in a case in which there are information sets of which an IOU is larger than the predetermined threshold (in other words, the overlapping degree is large), elements of class reliabilities of M dimensions are compared with each other, and only an information set having higher class reliability is caused to remain. In other words, a value of an information set having lower class reliability is changed to zero. This process is performed for all the combinations of the information sets. In other words, in the subject estimating process, an IOU is calculated in order from the first information set of all the information sets and is compared and changed.

In addition, originally, in the subject estimating process, when the IOU is large, comparison/update is performed, and when the IOU is small, nothing is performed. Thus, whether the IOU is larger or smaller than a predetermined threshold, in other words, need/no-need for comparison/update needs to be able to be instructed from the outside.

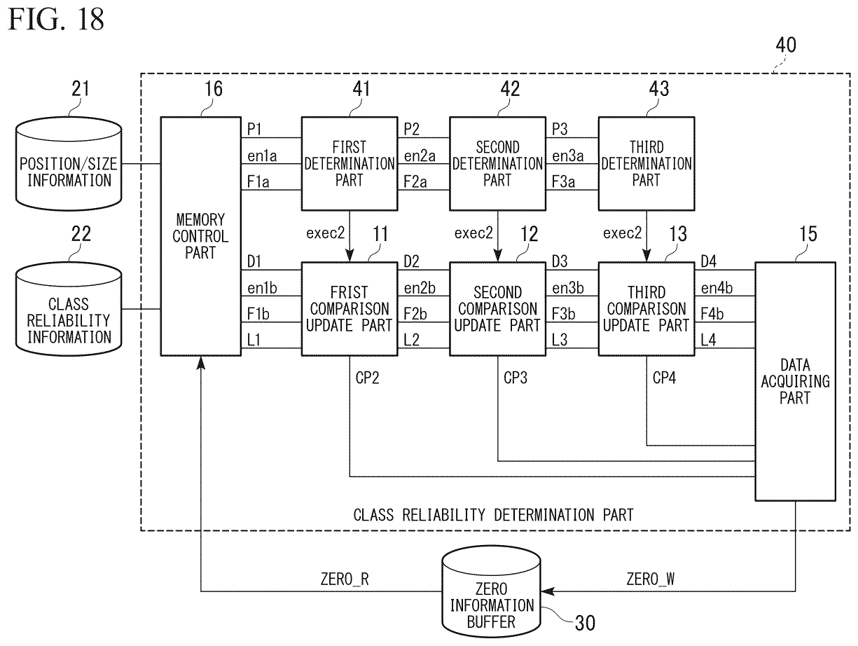

FIG. 18 is a block diagram illustrating a class reliability determining part 40 according to this embodiment. Points different from the data comparing part 10 according to the first embodiment illustrated in FIG. 12 are that determination parts 41, 42, and 43 are disposed, and the data storage buffer is divided into a position/size information buffer 21 and a class reliability information buffer 22. The determination part and the comparison update part form a pair, and a process is performed for data of the same information set. The determination part determines whether or not an IOU is larger than a predetermined threshold.

Position/size information (P*) included in information sets is input to the determination part through a memory control part 16. The determination part calculates an IOU from the position/size information of the information sets and, in a case in which the IOU is larger than a predetermined threshold, determines that there is a high possibility of being the same subject and transmits a trigger exec=1 (comparison/update execution/no-execution determination signal) to the comparison update part.

The comparison update part receives class reliability information and performs a comparison/update process of each element of the class reliability of M dimensions when exec=1, and all the elements of the comparison value or the comparison target value are not zero and skips the process otherwise. In other words, only when a comparison/update execution/non-execution determination signal is input in synchronization with stream data, and the comparison/update execution/non-execution determination signal indicates execution, the comparison update part performs comparison/update of data. In this way, the comparison update part performs the process only in a case in which the IOU is large.

Operations of the comparison update part are the same as those of the first embodiment illustrated in FIG. 12 except that the trigger exec is input from the determination part. In other words, in this embodiment, a reliability determination result (exec) according to an IOU calculation result is input from the outside (the determination part).

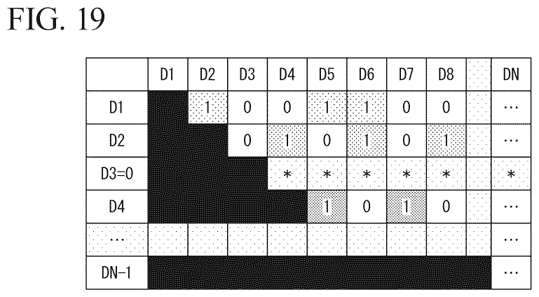

FIG. 19 is a diagram illustrating an example of a reliability determination result acquired by the determination part. A place of the flag 1 represents that the IOU is determined to be large. For example, between D1 and D2, between D1 and D5, and between D1 and D6, the IOU is determined to be large.

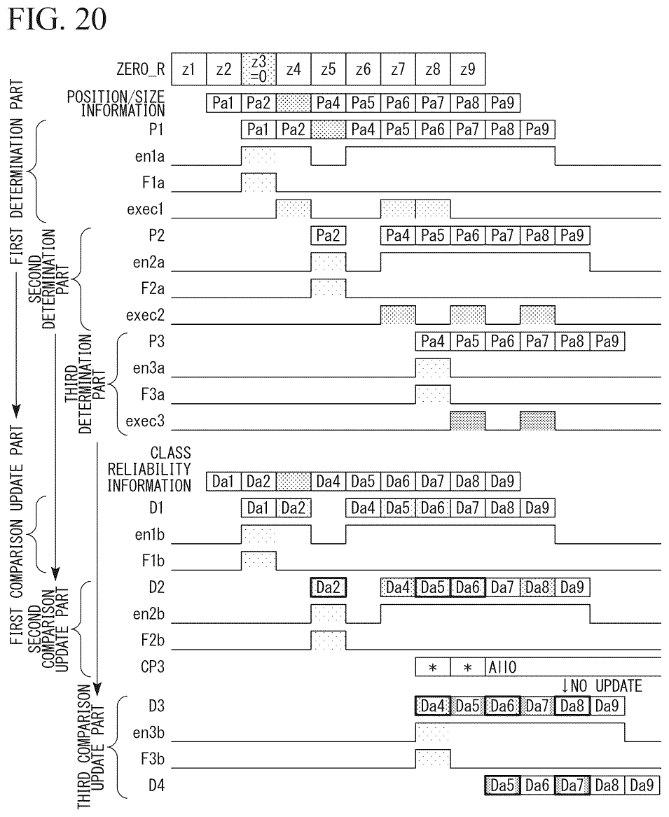

FIG. 20 is a diagram illustrating an example of a timing diagram according to this embodiment. On a lower side in the drawing, the flow of the process of the comparison update part is illustrated, and the process of the comparison update part is similar to that according to the first embodiment illustrated in FIG. 13. In addition, similar to the example illustrated in FIG. 16, a case in which data (z3=0) in which all the elements are zero is initially input, and all the elements of CP3 become zero in the middle of the process is illustrated.

As the reliability determination result illustrated in FIG. 19, since the IOU is determined to be large between D1 and D2, between D1 and D5, and between D1 and D6, a pulse of exec1 is up in that part. In accordance with the timing matching that, the comparison update part performs comparison/update only when the pulse of exec1 is up.

In the first comparison update part, D1 is compared/updated with a comparison target value for Db2, Db5, and Db6 for which exec1=1. In the second comparison update part, in D2, Dc4, Dc6, and Dc8 for which exec2=1 are compared and updated with a comparison target value, and, as a result of comparison between CP3 and Dc6, all the elements of CP3 become zero, and thus even if the subject reliability is known to be low thereafter, there is no changed in the result of the comparison/update. For this reason, comparison/update after Dc7 is not performed, and Dc8 that is a comparison/update target is also output as it is.

By employing the configuration as described above, this embodiment can be applied to a subject estimating process of deep learning. In addition, in the description presented above, although the determination part and the comparison update part have been described to have mutually-different configurations, they may be formed on the same circuit. In such a case, position/size information corresponding to class reliability information to be compared is input to the comparison update part, an IOU is calculated, and comparison/update execution/non-execution is determined.

As above, although the embodiments of the present invention have been described above, the technical scope of the present invention is not limited to the embodiments described above, and the combination of constituent elements may be changed, or each constituent element may be variously changed or deleted in a range not departing from the concept of the present invention.

Each constituent element is for describing functions and processes relating to the constituent element. Functions and processes relating to a plurality of constituent elements may be realized at the same time by one component (circuit).

Each constituent element may be realized by a computer formed from one or a plurality of processors, a logic circuit, a memory, an input/output interface, a computer-readable recording medium, and the like respectively or as a whole. In such a case, by recording a program for realizing the function of each or all of the constituent elements in a recording medium and causing a computer system to read and execute the recorded program, various functions and processes described above may be realized.

In this case, for example, the processor is at least one of a CPU, a digital signal processor (DSP), and a graphics processing part (GPU). For example, the logic circuit is at least one of an application specific integrated circuit (ASIC) and a field-programmable gate array (FPGA).

The “computer system” described here may include an OS and hardware such as peripherals. In addition, in a case in which a WWW system is used, “computer system” also includes a home page providing environment (or a display environment). Furthermore, the “computer-readable recording medium” represents a writable nonvolatile memory such as a flexible disk, a magneto-optical disk, a ROM, or a flash memory, a portable medium such as a CD-ROM, or a storage device such as a hard disk built into the computer system.

In addition, the “computer-readable recording medium” includes a medium storing the program for a predetermined time such as an internal volatile memory (for example, a Dynamic Random Access Memory (DRAM)) of a computer system serving as a server or a client in a case in which the program is transmitted through a network such as the Internet or a communication line such as a telephone line.

In addition, the program described above may be transmitted from a computer system storing this program in a storage device or the like to another computer system through a transmission medium or a transmission wave in a transmission medium. Here, the “transmission medium” transmitting a program represents a medium having an information transmitting function such as a network (communication network) including the Internet and the like or a communication line (communication wire) including a telephone line. The program described above may be used for realizing a part of the functions described above. In addition, the program described above may be a program realizing the functions described above by being combined with a program recorded in the computer system in advance, a so-called a differential file (differential program).

The present invention can be broadly applied to arithmetic operation processing devices.

What is claimed is:

1. An arithmetic operation processing device comprising:
a comparison update part configured to store first data of a data stream of an input information set as a comparison target value, compare the comparison target value with a comparison value by using data other than the first data as the comparison value, update both of the values on the basis of a comparison result, and output the updated comparison value to a later stage;
a data comparing part in which K comparison update parts are connected in multiple stages;
a data storage buffer, in which N information sets that are data columns are stored, formed from a memory;
a data acquiring part configured to sequentially acquire the comparison values that are output data of the comparison update parts connected in the multiple stages and thereafter acquire the comparison target values of the comparison update parts; and
a memory control part,
wherein the memory control part:
consecutively reads the information sets from a data stream stored in the data storage buffer, reads data that initially becomes the K comparison target values, and transmits the K comparison target values to the K comparison update parts of the data comparing part;
when all the comparison target values are read from the data storage buffer, next, reads all data other than the data that becomes the comparison target values from the data storage buffer; and
in a case in which comparison of a second time or a subsequent time is performed, reflects update details until comparison of the previous time in the data acquired from the data storage buffer and outputs resultant data to the comparison update part.

2. The arithmetic operation processing device according to claim 1, further comprising a zero information buffer formed from a memory in which zero information that can be used for identifying whether or not an updated data element is zero is stored,
wherein the data acquiring part writes zero information that can be used for identifying a data element of which a value has been updated into the zero information buffer when the comparison values present in output data of the comparison update parts connected in the multiple stages are sequentially acquired and writes zero information in the zero information buffer also for the comparison target value when the comparison target value is acquired from the comparison update part after acquisition of all the comparison values from the comparison update parts ends; and
in a case in which comparison of a second time or a subsequent time is performed, the memory control part simultaneously reads zero information forming a pair with a data element to be compared from the zero information buffer, reflects update details until comparison of the previous time in data acquired from the data storage buffer, and outputs resultant data to the comparison update part.

3. The arithmetic operation processing device according to claim 1, wherein, in a case in which, as a result of reflection of change details in data, the value becomes a value that does not need to be compared with the other data anymore, the memory control part excludes the data as invalid data from the data stream.

4. The arithmetic operation processing device according to claim 1, wherein, in a case in which the stored comparison target value becomes a value that does not need to be compared with other data anymore, the comparison update part performs through output of the data without performing comparison/update.

5. The arithmetic operation processing device according to claim 1, wherein the comparison update part receives a comparison/update execution/non-execution determination signal in synchronization with stream data as its input and performs comparison/update of the data only when the comparison/update execution/non-execution determination signal indicates execution.

6. The arithmetic operation processing device according to claim 2, wherein
the information set is an information set formed from a feature quantity of a subject in a subject estimating process of a later stage of a CNN using deep learning, and each information set includes class reliability information having independent elements of M dimensions,
the arithmetic operation processing device further comprising a position/size information storage buffer in which a position and a size of a detected subject are stored having 1:1 correspondence with the class reliability information,
the comparison/update performed by the comparison update part is an operation of comparing values of the class reliability information for each dimension and substituting a smaller value with zero,
zero information stored in the zero information buffer is information that can be used for determining whether or not a value of the class reliability information for each dimension is zero, and
the comparison update part calculates an IOU that is a numerical value representing an overlapping degree of frames at the time of displaying position/size information of subjects extracted from the information sets as the frames on an image from the position/size information corresponding to the class reliability information to be compared and performs comparison/update only when the IOU is equal to or greater than a predetermined threshold.

7. The arithmetic operation processing device according to claim 6, wherein
the zero information stored in the zero information buffer is a flag in which a part in which the value of the class reliability information for each dimension is zero is set as 1, and the other parts are set as 0, and
when all the zero information of the zero information buffer is 1, the memory control part determines that comparison with other data is not necessary.
